(19) United States
(12) Patent Application Publication
(10) Pub. No.: US 2018/0126357 A1
(43) Pub. Date: May 10, 2018

(54) METHOD FOR TAILORING ELECTRICAL RESISTIVITY OF MOLECULAR SIEVE ADSORBENTS FOR RESISTIVE HEATING APPLICATION

(71) Applicant: The Governors of the University of Alberta, EDMONTON (CA)

(72) Inventors: Zaher Hashisho, EDMONTON (CA); Pooya Shariaty, EDMONTON (CA)

(21) Appl. No.: 15/807,285

(22) Filed: Nov. 8, 2017

Related U.S. Application Data
(60) Provisional application No. 62/419,798, filed on Nov. 9, 2016.

(51) Int. Cl. B01J 20/18; B01D 53/04; B01J 20/20; B01J 20/32; B01J 29/072

(52) U.S. Cl. CPC B01J 20/183; B01D 53/04; B01J 20/20; B01J 20/324; B01J 20/3204; B01D 2253/204; B01J 29/072; B01D 2253/102; B01D 2253/104; B01D 2253/108; B01D 2253/116; B01J 20/3236

(57) ABSTRACT

A molecular sieve adsorbent composition is provided that includes an inorganic molecular sieve having a surface and a native adsorption property. Carbon having a mean domain size of between 1 and 10 nm is deposited on the surface or admixed into contact with the surface in an amount to reduce the resistivity and within 10% of the native adsorption property. A method for producing an inorganic molecular sieve adsorbent composition includes the application of carbon having mean domain sizes of between 1 and 10 nanometers to a surface of the inorganic molecular sieve adsorbent composition at a temperature that does not exceed 400° C. and under a controlled gaseous environment to produce a carbon containing inorganic molecular sieve adsorbent composition. The carbon containing inorganic molecular sieve adsorbent composition is removed from the controlled gaseous environment to obtain the inorganic molecular sieve adsorbent composition with the decreased resistivity.

### CROSS-REFERENCE TO RELATED APPLICATION

This application claims priority of U.S. Provisional Patent Application Ser. No. 62/419,798 filed Nov. 9, 2017, which is incorporated herein by reference.

### TECHNICAL FIELD

The present invention generally relates to the field of material science, and more specifically to a method for tailoring the electrical resistivity of molecular sieve adsorbents.

### BACKGROUND

Adsorption is the interaction of atoms, ions, biomolecules, or molecules of gas, liquid, or dissolved solids on a surface. The adsorption process creates a film of the adsorbate (the molecules or atoms being accumulated) on the surface of the adsorbent. After adsorption, the adsorbents should be regenerated for reuse. The regeneration (removal of the adsorbates from the surface of the adsorbent to recover its adsorption capacity) may be done by increasing the temperature of the adsorbent.

Pressure swing regeneration (PSR) and temperature swing regeneration (TSR) are used industrially for regenerating adsorbents and recovering their adsorption capacity. However, conventional TSR and PSR techniques including steam, hot gas, conductive heating, and vacuum regeneration have high energy consumption, are slow, and may alter the physical/chemical properties of the adsorbents and adsorbates.

Resistive, also known synonymously as joule, heating is an efficient method for regenerating adsorbents. Compared to conventional TSR and PSR methods, resistive heating is faster, may have higher desorption efficiency, and requires less energy to achieve a desired desorption efficiency. However, the applicability of resistive heating is dependent on the electrical resistivity of the adsorbent.

Resistive heating is an adsorbent regeneration technique where electric current is passed through a material with sufficiently low resistivity, typically, 0.1-10 Ω.m, and heat is generated by the Joule effect, which allows for rapid adsorbent regeneration that is decoupled from the purge gas flow. Molecular sieves are effective adsorbents because they have tailored and structured pore size distributions. Unlike carbonaceous materials, however, molecular sieves have high electrical resistivity that prevents their regeneration by resistive heating. Thus, while resistive heating is a well-established technique for regeneration of carbonaceous adsorbents, with typical resistivities of 0.2-0.8 Ω.m, such as activated carbon fiber cloth, most inorganic adsorbents, including molecular sieves have low conductivity and cannot be heated resistively. Inorganic absorbent resistivities typically being resistivity of >10⁷ Ω.m.

Conventional heating methods may require high energy consumption, while resistive (joule) heating may be used as an alternative low energy consumption and fast heating method. Resistive heating may be applied for regeneration of materials with low electrical resistivity, while resistive heating is not applicable for highly resistive materials including most inorganic adsorbents.

Therefore, a method is needed to tune the electrical resistivity of molecular sieve adsorbents in order to allow for resistive heating of molecular sieve adsorbents without altering the adsorption properties of the adsorbent (substrate).

### SUMMARY OF THE INVENTION

A molecular sieve adsorbent composition is provided that includes an inorganic molecular sieve having a surface and a native adsorption property. Carbon having a mean domain size of between 1 and 10 nm is deposited on the surface or admixed into contact with the surface in an amount to reduce the resistivity to less than 10 Ω.m and within 10% of the native adsorption property.

A method for producing a modified inorganic molecular sieve adsorbent composition with a decreased resistivity includes the application of catalytic deposition of carbon having mean domain sizes of between 1 and 10 nanometers to a surface of the inorganic molecular sieve adsorbent composition at a temperature that does not exceed 400° C. and under a controlled gaseous environment to produce a carbon containing inorganic molecular sieve adsorbent composition. The carbon containing inorganic molecular sieve adsorbent composition is removed from the controlled gaseous environment to obtain the inorganic molecular sieve adsorbent composition with the decreased resistivity.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1 is a block diagram of a method for tailoring the electrical resistivity of molecular sieve adsorbent in accordance with embodiments of the invention;

FIG. 2 is a plot temperature versus time for the thermal conditioning applied for deposition of carbon nano structure on the surface of zeolite in accordance with embodiments of the invention;

FIG. 3 shows a schematic diagram of a set-up for resistivity measurement and a resistive heating apparatus;

FIG. 4 are a series of photographs of SEM images of modified zeolite with respect to as-received zeolite;

FIG. 5 is a plot of XRD patterns for as-received and modified zeolite;

FIG. 6 is a plot of a curve which shows the temperature profile during resistive heating of modified zeolite;

FIG. 7 is a plot of curves showing nitrogen adsorption isotherms for as-received and modified zeolite; and

FIG. 8 is a plot of curves showing MEK adsorption isotherms for as-received and modified zeolite.

FIG. 9 is a plot of curves showing effectiveness of direct addition of carbon to the molecular sieve structure compared to physical mixing of carbon

### DETAILED DESCRIPTION

The present invention has utility as a method for tailoring electrical properties of molecular sieve adsorbents. The method is a low temperature modification method of molecular sieve adsorbents to tailor its electrical resistivity for resistive heating applications under conditions that have been adjusted to preserve the adsorption properties of the adsorbent (substrate) while enhancing its electrical resistivity. In some inventive embodiments, carbon inclusions are provided to low conductivity molecular sieve adsorbents. Since carbon is a medium for the electric current to pass through the bed, the carbon is heated resistively (Joule effect) and can heat the adsorbent by thermal conduction mechanism. As a result, the form, size, and amount of added carbon are important parameters for this purpose.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Resistive heating, as an alternative to currently used conventional heating adsorbent regeneration methods, is faster, can have higher desorption efficiency, is decoupled from the purge gas, and requires less energy to achieve a desired regeneration efficiency. Furthermore, using resistive heating as a regeneration technique may allow for in-situ adsorption/regeneration with notably lower energy consumption, which is of huge benefit for different processes (specifically, adsorptive separation processes, where molecular sieve adsorbents are mainly used). The application of this heating method for regeneration of carbonaceous adsorbents has been well established due to the aforementioned advantages; however, its application for heating of molecular sieve adsorbents is not feasible due to their significantly higher electrical resistivity. The disclosed inventive procedure provides the methodology needed to tailor molecular sieve adsorbents electrical resistivity without appreciably compromising their native adsorption properties. The inventive method makes it possible to resistively heat highly resistive molecular sieve adsorbents without affecting their adsorption performances.

As used herein “without appreciably compromising their native adsorption properties” is defined as having an adsorption property within 10% of a material absent the inventive carbon domains when normalized for the weight of the inorganic material.

In specific embodiments of the inventive method carbon nanostructure is added to the zeolite Y (highly resistive molecular sieve, >10⁺⁷ Ω.m) to decrease the resistivity. Carbon is applied physical mixing with resistively heating carbon particles (e.g. powder, nanotube) orby hydrocarbon decomposition on metal catalyst impregnated zeolite Y. Other suitable zeolites include (A, X, Y in undoped form), mixed coordination molecular sieves, as well as molecular sieve adsorbents illustratively including: zeolites (classical and natural zeolite), templated zeolites (ZSM-5, ZSM 20), Aluminophosphate adsorbents (SAPO-43, MeAPO), non-crystalline mesoporous molecular sieves (MCM-41, MCM-48), mixed coordination molecular sieves (ETS-2, ETS-4, ETS-10), metal organic frameworks (MOFs), or any other type.

Hydrocarbons operative herein a gaseous under standard temperature and pressure (STP), these illustratively include alkanes of methane, ethane, propane, butane, and isobutane; alkenes of ethene, propene, butene, and isobutene; and alkynes of acetylene, propyne, and 1-butyne. Different metal catalyst impregnation conditions and decomposition temperatures are used for carbon deposition on the zeolite Y. Modified samples are characterized using bulk elemental (CHN) analysis, scanning electron microscopy (SEM), X-ray diffraction (XRD), and resistivity measurements. CHN and SEM confirmed the addition of nanostructured carbon onto the zeolite Y. Results from resistivity measurements showed that carbon nanostructure addition decreased the resistivity of the zeolite by up to 8 orders of magnitude.

In another inventive embodiment, the resistivity of samples is decreased by physically mixing carbon (different form such as powder, nanotube, etc.) in different ratios to an inorganic molecular sieve material. As is shown herein, the resistivity is decreased more efficiently, as a function of weight added, by adding carbon directly to the structure of zeolite in the form of nano structured carbon.

Embodiments of the inventive method include a low temperature chemical vapor decomposition of a carbon base compound over a molecular sieve adsorbent impregnated with a metal catalyst, and mixing of a molecular sieve adsorbent powder with a solution of a metal cation through sonication. The molecular sieve adsorbent may be one or more of classical zeolites (A, X, Y), mixed coordination molecular sieves, as well as molecular sieve adsorbents illustratively including: zeolites (classical and natural zeolite), templated zeolites (ZSM-5, ZSM 20), Aluminophosphate adsorbents (SAPO-43, MeAPO), non-crystalline mesoporous molecular sieves (MCM-41, MCM-48), mixed coordination molecular sieves (ETS-2, ETS-4, ETS-10), metal organic frameworks (MOFs), or any other type. In specific embodiments of the inventive method temperatures are maintained below 400° C. for two main reasons: (1) avoiding a complete formation (only partial formation) of the carbon nanotube (CNT) on the adsorbents, and (2) low thermal stability of some of molecular sieve adsorbents (e.g., ETS-10 and MOFs), in which the adsorbents crystalline structure could be destroyed at temperatures higher than 450° C.

The metal may be selected among metals with high carbon solubility illustratively including but not limited to Co, Fe, and Ni. After sonication, the mixed solution is dried out in the oven overnight. The resulting powder is placed in a furnace. The metal cation is converted to a metal catalyst by exposure to a hydrogen contained gas through a suitable thermal condition. The impregnated molecular sieve is then exposed to a carbon source gas at a suitable thermal condition in order to deposit carbon on the surface of the material. The carbon source gas may be selected from among low bond energy organic compounds illustratively including STP gaseous hydrocarbons such as alkanes of methane, ethane, propane, butane, and isobutane; alkenes of ethene, propene, butene, and isobutene; and alkynes of acetylene, propyne, and 1-butyne. Embodiments of the inventive procedure result in deposition of nanoscale structured carbon on the surface of molecular sieve, which enhance electrical conductivity without compromising adsorption properties. The deposited carbon has mean domain sizes of between 1 and 10 nm as measured by Debye-Scher line broadening as measure in X-ray powder diffraction. The amount of carbon so applied to the surface is around 10% total weight percent and reduces the resistivity to around 1 Ω.m. It has also been found that the location of the deposited carbon is also important to preserve the adsorption properties and crystalline structure of the molecular sieve adsorbents. Prior art methods have resulted in carbon deposition at different locations on or within the substrate. Consequently, by using embodiments of the inventive method the same adsorption behavior may be observed by the adsorbent, while an energy efficient and fast heating technique illustratively including resistive heating may be employed.

Carbon in some inventive embodiments is to inorganic molecular adsorption material compositions by chemical vapor decomposition (CVD) of a hydrocarbon precursor. This method, while well described in the prior art literature for applications such as carbon nanotubes (CNT) preparation, has not been approached and utilized to improve electrical conductivity of molecular sieves and allow resistive heating of adsorbents. Previous work on the addition of carbon to a substrate primarily used high temperature and focused more on the carbon formation regardless of the changes in properties of the substrate. The use of CVD for the above-mentioned purpose, however, should be done without compromising molecular sieve adsorption properties.

Successful implementation of embodiments of the inventive method may allow for non-limiting applications illustratively including regenerative gas purification cartridge systems (e.g., moisture, oxygen, hydrocarbon, CO₂, sulfur traps used prior to gas chromatography column), adsorbent trap for concentrating air samples, zeolite monolith for adsorptive separation processes (e.g., CO₂ capturing, VOC abatement systems), zeolite separation membranes, zeolite assisted gas sensors, and regenerative adsorbent cartridges used as mask respirator filters.

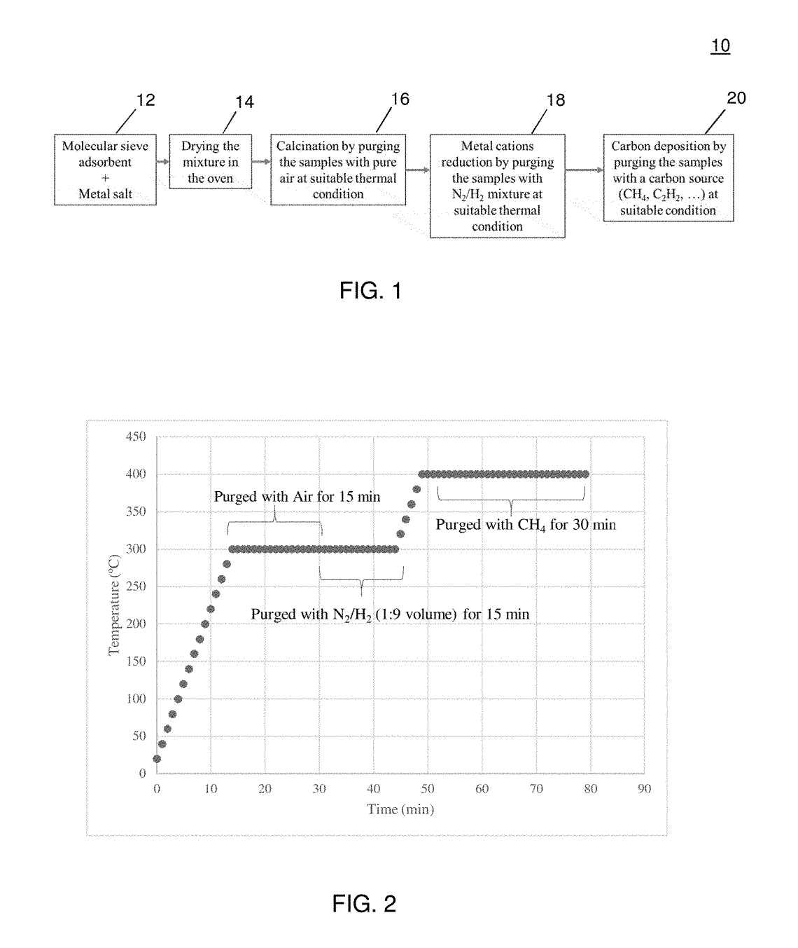

Referring now to the figures, FIG. 1 illustrates a method 10 of tuning electrical resistivity of molecular sieve adsorbent. Zeolite HY901, cobalt nitrate, and CH₄ are used as molecular sieve adsorbent, metal salt, and carbon source in this study, respectively. Cobalt salt (Co(NO₃)2.6H₂O) is dissolved in deionized water, and mixed with HY901 by weight ratio of 1:1 through sonication for 1 hour at 25° C. (block 12). The resulting mixture is then dried at 90° C. overnight in the oven (block 14). Calcination by purging is performed by purging the dried samples with pure air at a suitable thermal condition (block 16). Metal cations are reduced by purging the samples with a N₂/H₂ mixture at a suitable thermal condition (block 18). Carbon deposition is performed by purging the samples with a hydrocarbon source as detailed above at a suitable condition (block 20). 0.5 gr of collected powder is added to a quartz reactor and placed in a tube furnace. FIG. 2 illustrates the thermal conditioning and purge gas composition used throughout the process. The thermal conditioning consists of three steps: calcination in order to remove the impurities from the powder, reduction of the deposited cobalt cation, and deposition of carbon on the surface of zeolite by CH₄ decomposition. A purge gas flowrate of 0.5 standard liters per minute (SLPM) is used during the thermal condition. In the specific inventive embodiment shown in FIG. 2 the sample is first purged with air for 15 minutes at 300° C., and then followed with a second purge with a mixture of N₂/H₂ (1:9 volume ratio) for an additional 15 minutes at 300° C. Subsequently the temperature is raised to 400° C. and a third purge with CH₄ is performed for 30 minutes.

Subsequently, field emission SEM is completed using a JAMP-9500F Auger microprobe (JEOL) to examine the morphology of the zeolite surface after modification. The accelerating voltage, emission current, working distance, and sample rotation are 15 kV, 8 nA, 24 mm, and 30 degree, respectively. An MS lens with 0.6% energy resolution is used for Auger spectroscopy and imaging.

Powder XRD patterns are acquired with a Rigaku Ultima IV unit equipped with a D/Tex detector and Fe filter to obtain the change in the crystallinity of zeolite after modification. Results are obtained using a cobalt tube (38 kV, 38 rnA) with an average K at wavelength of 1.790260 A. Samples are run from 5 to 90° on a continuous scan using a top-pack mount at 2° 28/min and step size of 0.02°. Patterns are characterized using JADE 9.1 with the 2011 ICDD database.

Bulk Elemental Analysis is used to measure the amount of added carbon on the zeolite using Organic Elemental Analysis (OEA) (Flash 2000, Thermo Fisher Scientific Inc.) with furnace and gas chromatograph column temperatures of 950° C. and 65° C., respectively. He (carrier gas), He (reference), and O₂ flow rates are 140, 250, and 100 ml/min, respectively. A 5 second oxygen dose is used and the run time is 12 minutes.

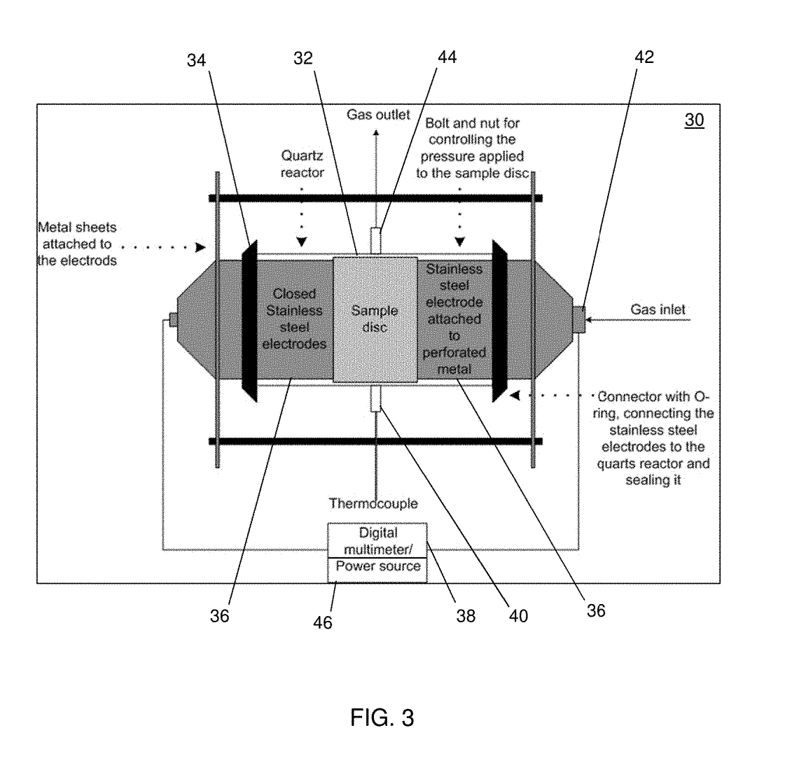

Resistivity measurements and resistive heating of the modified sample are completed using the setup 30 illustrated in FIG. 3. For this purpose, the modified sample (no binder) is pressed at 4 kPSI to form a disc 32. The setup includes a sample holder 34, electrodes 36, digital multimeter 38, thermocouple 40, and purge gas (N₂) inlet 42 and purge gas outlet 44. During resistivity measurement, samples are purged with 0.5 SLPM N2. Resistive heating of the modified samples is completed using the same apparatus after replacing the digital multimeter 38 with a power source 46.

Adsorption properties of the samples are evaluated using nitrogen adsorption isotherm (using Autosorb-1, Quantachrome Instruments) at 77K with nitrogen as the testing gas. The adsorption isotherm covered partial pressures ranging from very low partial pressure (10⁻⁷) to near saturation. Organic adsorption isotherms are obtained using a sorption analyzer (TA Instruments, model VTI-SA) at 25° C. with N2 carrier gas and varying concentrations of methyl ethyl ketone (MEK, as a test organic vapor). The system logged the equilibrium weight of the sample (5-7 mg) in response to a step change in the concentration of the adsorbate (relative pressure range of 0.02-0.9). Equilibrium is assumed when the weight changed by <0.001 wt % in 5 minutes.

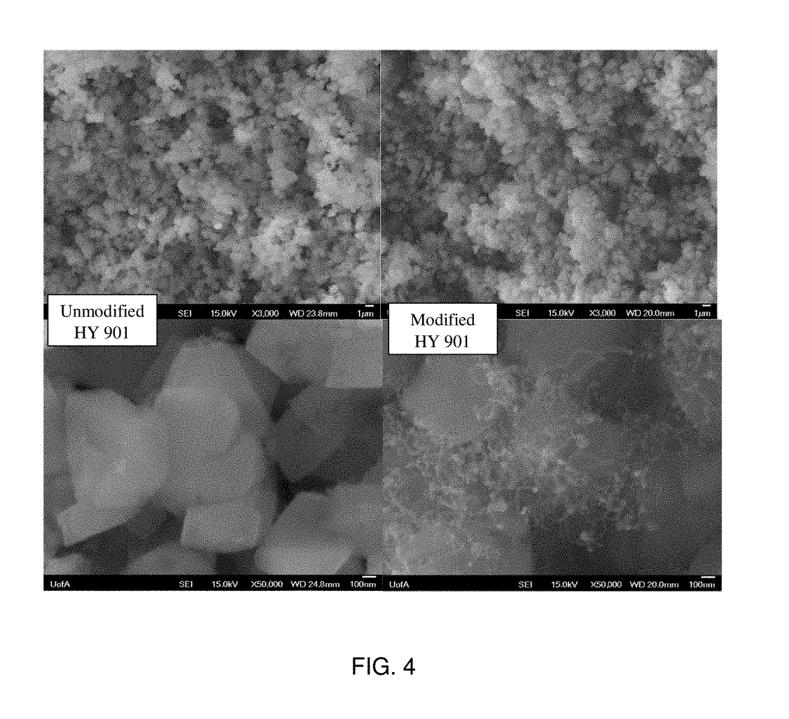

Referring to FIG. 4, a SEM picture demonstrates the formation of nanoscale structured carbon on the surface of zeolite. The nanostructured carbon is grown on the surface of the zeolite from different sites. The diameter of the deposited carbon is <10 nm. While the carbon is deposited on the surface of zeolite, it should be noted that the surface is still accessible for adsorption.

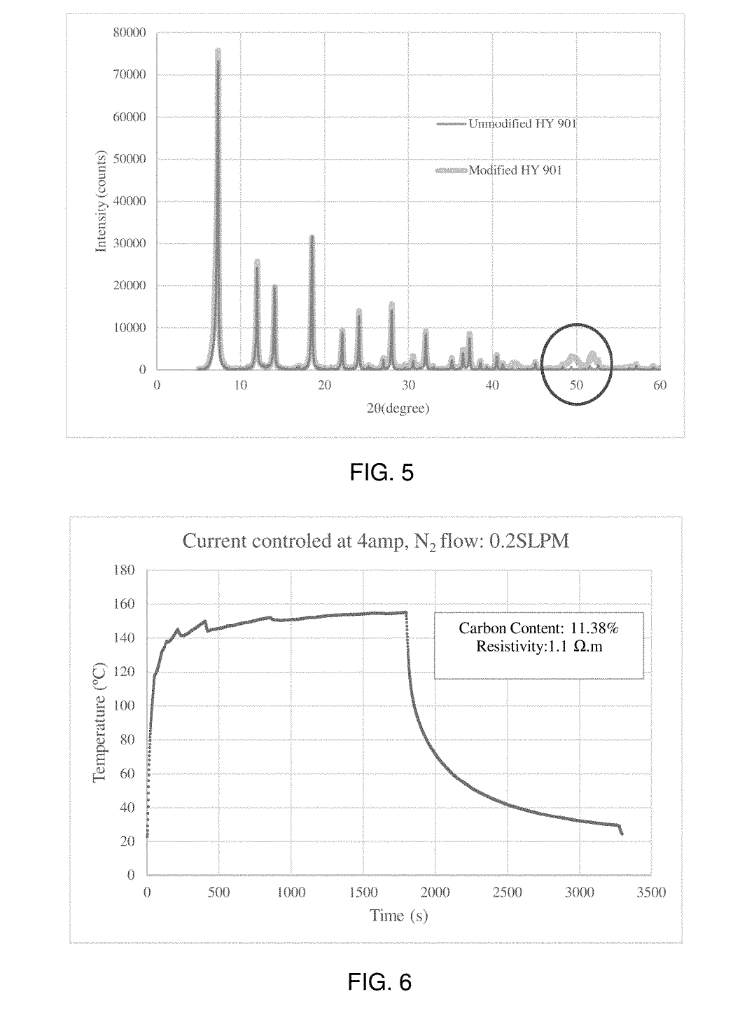

Referring to FIG. 5, the XRD pattern for modified zeolite includes similar peaks to the XRD pattern of the original unmodified HY901, while additional peaks appeared around angle of 20=50 (degree). Additional peaks may be associated with the formation of nanostructured carbon, which implies that a nano structured carbon is formed on the surface of zeolite without compromising its crystalline structure.

Referring to FIG. 6, the amount of carbon added to the zeolite is measured as 11.38 wt %, which resulted in reduction of the zeolite resistivity from >10⁷ to 1.1 Ω.m. The modified zeolite could be heated using the resistive heating as demonstrated in FIG. 6. While it is the preliminary resistive heating test, the result indicated that the modified sample may be heated using resistive heating as fast as 2° C./sec under applied condition.

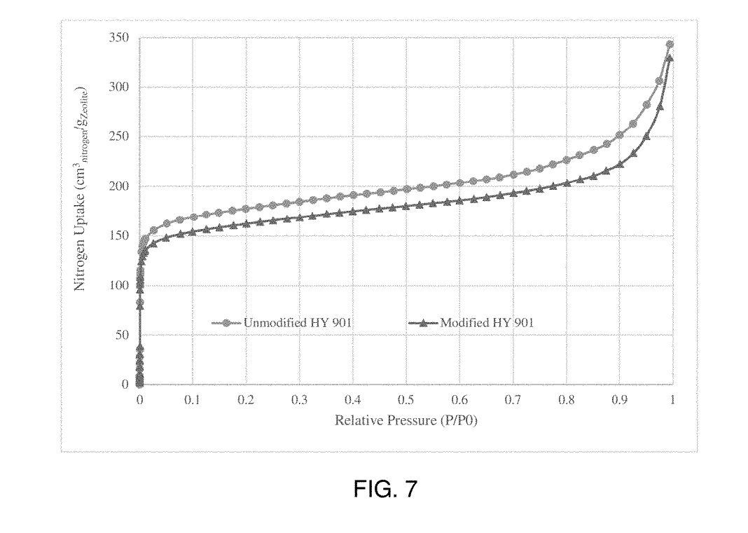

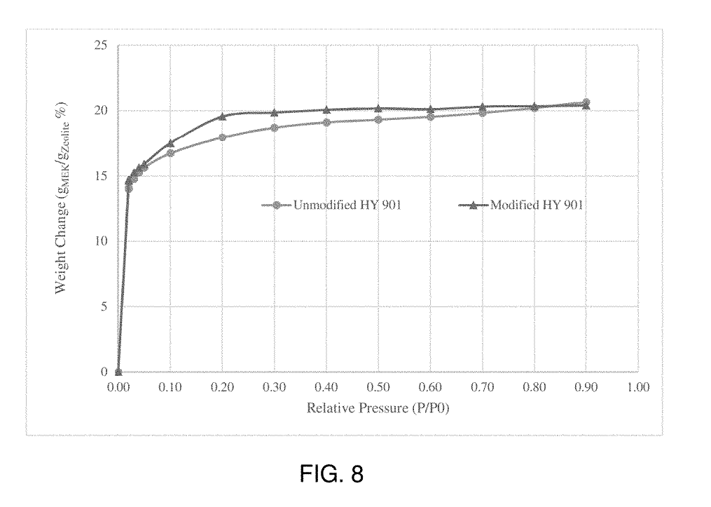

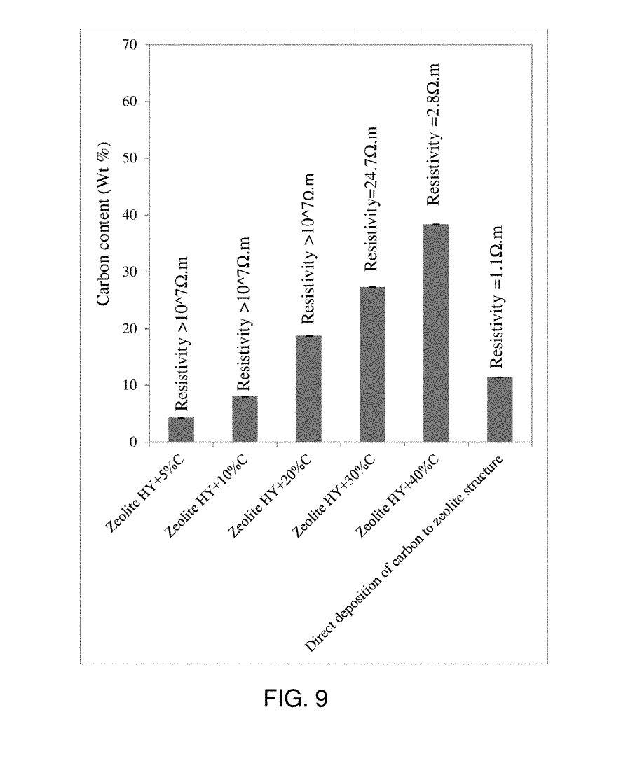

Referring to FIG. 7 and FIG. 8, similar nitrogen and organic adsorption isotherms are obtained for both unmodified and modified zeolites. The results confirm the minor change in the adsorption properties of the zeolite after modification. The adsorption isotherms also confirm that zeolite surface is still accessible for adsorption by addition of the nanostructured carbon to its surface.

Based on the results, a method for low temperature chemical vapor decomposition for tailoring electrical resistivity of a molecular sieve has been found. The inventive procedure resulted in formation of nanoscale structured carbon on the surface of zeolite, while keeping the surface accessible for adsorption. The resistivity of zeolite reduced for >10⁷ to 1.1 am by addition of 11.38 wt % carbon on the zeolite surface after modification. The sample could be heated afterward using resistive heating with a relatively fast heating rate

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A molecular sieve adsorbent composition comprising:
an inorganic molecular sieve having a surface and a native adsorption property;
carbon having a mean domain size of between 1 and 10 nm on the surface or admixed into physical contact with the surface in an amount to reduce the resistivity to around 1 Ω.m and within 10% of the native adsorption property.

2. The composition of claim 1 wherein the inorganic molecular sieve is a zeolite of type A, X, or Y, or a metal doped version thereof.

3. The composition of claim 1 wherein the inorganic molecular sieve is a natural zeolite, templated zeolites, or a metal doped version thereof.

4. The composition of claim 1 wherein the inorganic molecular sieve is an aluminophosphate adsorbent, or a metal doped version thereof.

5. The composition of claim 1 wherein the inorganic molecular sieve is non-crystalline mesoporous molecular sieve, or a metal doped version thereof.

6. The composition of claim 1 wherein the inorganic molecular sieve is a mixed coordination molecular sieves, or a metal doped version thereof.

7. The composition of claim 1 wherein the inorganic molecular sieve is a metal organic framework.

8. The composition of claim 1 wherein the carbon is present around 10% of total weight percent.

9. A method for producing an inorganic molecular sieve adsorbent composition with a decreased resistivity comprising:
applying carbon having mean domain sizes of between 1 and 10 nanometers to a surface of the inorganic molecular sieve adsorbent composition at a temperature that does not exceed 400° C. and under a controlled gaseous environment to produce a carbon containing inorganic molecular sieve adsorbent composition; and
removing the carbon containing inorganic molecular sieve adsorbent composition from the controlled gaseous environment to obtain the inorganic molecular sieve adsorbent composition with the decreased resistivity.

10. The method of claim 9 wherein the applying carbon is by chemical vapor deposition of a precursor.

11. The method of claim 10 wherein the precursor is a gaseous hydrocarbon under standard temperature and pressure.

12. The method of claim 9 wherein the applying carbon is by physical mixing of different form of powdered carbon with a molecular sieve adsorbent.

13. The method of claim 9 wherein the applying carbon is by physical mixing of different form of pre-synthesized carbon nanotube with a molecular sieve adsorbent.

14. The method of claim 9 wherein the applying carbon is by physical mixing of different form of pre-synthesized graphite with a molecular sieve adsorbent.

15. The method of claim 9 further comprising exposing the inorganic molecular sieve adsorbent composition a solution of metal cations; drying the solution to form a metal cation coated powder; heating the metal cation coated powder in a furnace under conditions to form a metal catalyst from the metal cations to form a treated impregnated molecular sieve prior to the applying carbon.

16. The method of claim 1 wherein the molecular sieve adsorbent is one or more of a classical zeolite A, classical zeolite X, classical zeolite Y, a mixed coordination molecular sieve, a natural zeolite, a templated zeolite, an aluminophosphate adsorbents, a non-crystalline mesoporous molecular sieve, a mixed coordination molecular sieve, and a metal organic frameworks, or a metal doped variant of any one of the aforementioned.

17. The method of claim 1 wherein the metal cation is a metals with a high carbon solubility, the metal cation being at least one of Co, Fe, and Ni.

18. The method of claim 1 wherein the carbon precursor is a hydrocarbon that is gaseous at standard temperature and pressure.
